(19) United States
(12) Patent Application Publication
(10) Pub. No.: US 2024/0381030 A1
(43) Pub. Date: Nov. 14, 2024

(54) THERMALLY CONDUCTIVE MICROSPEAKER SUSPENSION

(71) Applicant: Google LLC, Mountain View, CA (US)

(72) Inventors: Timothy A. Gladwin, Mountain View, CA (US); Mark William Starnes, Sunnyvale, CA (US); Rajiv Bernard Gomes, San Jose, CA (US)

(21) Appl. No.: 18/691,618

(22) PCT Filed: Oct. 12, 2022
(86) PCT No.: PCT/US2022/046401

§ 371 Date: Mar. 13, 2024

Related U.S. Application Data
(60) Provisional application No. 63/255,149, filed on Oct. 13, 2021.

(51) Int. Cl. H04R 9/02; H04R 9/04; H04R 9/06

(52) U.S. Cl. CPC H04R 9/022; H04R 9/045; H04R 9/06; H04R 2400/11

(57) ABSTRACT

A microspeaker, includes a frame defining a space; a coil positioned in the space such that the frame extends around a perimeter of the coil; and a suspension suspending the coil within the space relative to the frame. The suspension is coupled to the frame and to the coil and allows the coil to vibrate in an axial direction during operation of the microspeaker, the suspension comprising a liquid metal polymer material. The suspension is formed from liquid metal particles embedded in a polymer matrix. The liquid metal polymer material is prestressed in a radial direction extending from the coil towards the frame. An outer perimeter of the suspension defines a first quadrilateral shape, and an inner perimeter of the suspension defines a second quadrilateral shape, the first and second quadrilateral shapes being concentric.

### CROSS-REFERENCE TO RELATED APPLICATIONS

This application claims the benefit of priority to U.S. Application No. 63/255,149, filed on Oct. 13, 2021, the contents of which are hereby incorporated by reference.

### TECHNICAL FIELD

This specification relates generally to microspeakers.

### BACKGROUND

This specification relates to microspeakers. Many electronic devices are capable of presenting multimedia content by including speakers which provide tonal, voice-generated, or recorded output. Some speakers are designed to have a smaller physical size for simple integration into various electronic devices having a range of different sizes (e.g., mobile phones, smart home devices).

The surround suspensions of many microspeakers have many requirements for flexibility, long fatigue life, and stability over a wide range of temperature and humidity conditions, water and pressure resistance, etc. The surround should provide a continuous seal to prevent acoustic leakage and cancellation. Where very little excursion (e.g., voice coil movement) is desired, as in compression drivers, metal surrounds can be used.

While metal surrounds typically have high thermal conductivity, the relatively large excursions of microspeakers often prevent use of metal surrounds. Microspeakers can use rubber, plastic, PEEK and other polymer materials to provide the necessary mechanical parameters of sealing, flexibility, and long life. However, these materials typically have poor thermal conductivity compared to metal. Furthermore, in many transducers and actuators, the suspension is primarily a mechanical device and is made from polymers which are relatively thermally insulating.

### SUMMARY

Disclosed are microspeakers with thermally conductive suspensions. The microspeakers may be suitable for use in electronic devices such as mobile phones. A microspeaker can be, for example, a speaker having a diameter that is two inches or less. In contrast, a mini speaker may be a speaker having a diameter that is two inches or more.

In some examples, a microspeaker has a voice coil that is a one-piece construction that is self-supporting and has a limited excursion. In some examples, a microspeaker has a diaphragm that is one piece. In some examples, the diaphragm can made from a polyester film or fabric that is woven and treated. In some examples, the diaphragm can be made from a laminated composite. In general, for a microspeaker and a mini speaker that have a same diameter, a microspeaker has a depth that is approximately half the depth of the mini speaker.

In the effort to further miniaturize microspeakers, it is desirable to apply higher power to a smaller device. This can result in very high voice coil temperatures which limit acoustic output and leads to excessive non-linear behavior and/or other undesirable consequences. There are typically limited paths to dissipate the heat from microspeakers. Polymer suspensions, or surrounds, used in microspeakers are usually poor thermal conductors (e.g., compared to metals) and may change mechanical properties with temperature. The suspensions are often thermally coupled directly to the source of heat in the microspeaker, e.g., the voice coil, and to the heat-sinking frame of the transducer, but the thermal path through the suspension is not efficient.

Electro acoustic transducers, actuators, speakers, and microspeakers can be relatively inefficient in converting electrical energy to acoustic energy. In some examples, microspeakers can have an efficiency of less than one percent. Most of the electrical energy provided to drive the microspeaker may be dissipated as heat, e.g., from resistive losses in the voice coil. Microspeaker transducers are often poor at conducting and radiating heat away from the voice coil. In the case where higher output or smaller size is desired, the power density can increase, causing the coil temperature to increase during operation. These higher temperatures can increase the coil resistance causing more losses due to power compression. Additionally, the higher temperatures from the voice coil may cause premature aging and failures of the coil insulation and the adhesives holding the coil to a diaphragm of the transducer.

Accordingly, it can be desirable to improve the heat dissipation from the coil, e.g., to the environment. Using thermally conductive suspensions can improve the conductive heat flow path away from the voice coil, e.g., to the frame of the microspeaker. A thermally conductive suspension can be made from materials such as liquid metal polymer materials. Liquid metal polymers can include liquid metals such as Gallium, and alloys of Gallium, combined with polymer material.

In general, one innovative aspect of the subject matter described in this specification can be embodied in a microspeaker, including: a frame defining a space; a coil positioned in the space such that the frame extends around a perimeter of the coil; and a suspension suspending the coil within the space relative to the frame. The suspension is coupled to the frame and to the coil and allows the coil to vibrate in an axial direction during operation of the microspeaker, the suspension including a liquid metal polymer material.

In general, one innovative aspect of the subject matter described in this specification can be embodied in a mobile device including the microspeaker. In general, one innovative aspect of the subject matter described in this specification can be embodied in a wearable device including the microspeaker

The foregoing and other embodiments can each optionally include one or more of the following features, alone or in combination. In some implementations, a power density of the microspeaker is 0.8 milliwatts per cubic millimeter or greater.

In some implementations, the suspension is formed from liquid metal particles embedded in a polymer matrix.

In some implementations, the liquid metal polymer material is prestressed.

In some implementations, the liquid metal polymer material is prestressed in a radial direction, the radial direction extending from the coil towards the frame.

In some implementations, the suspension includes one or more liquid metal channels.

In some implementations, the one or more liquid channels extend radially from the coil towards the frame.

In some implementations, the one or more liquid channels each include at least one fluid diode.

In some implementations, the at least one fluid diode directs a flow of liquid metal in a direction from the coil towards the frame.

In some implementations, a thickness of the suspension in the axial direction is 0.2 millimeters or less.

In some implementations, a volume fraction of liquid metal particles in the suspension is ten percent or greater.

In some implementations, a volume fraction of the liquid metal particles in the suspension is fifty percent or less.

In some implementations, an outer perimeter of the suspension defines a first quadrilateral shape, and an inner perimeter of the suspension defines a second quadrilateral shape, the first and second quadrilateral shapes being concentric.

In some implementations, at least one of the first quadrilateral shape or the second quadrilateral shape has rounded corners.

In some implementations, a distance between the outer perimeter and the inner perimeter defines a width of the suspension.

In some implementations, the width of the suspension is 2 mm or less.

In some implementations, the width of the suspension is 1 mm or more.

In some implementations, the first quadrilateral shape and the second quadrilateral shape each are approximately square.

In some implementations, a length of each side of the first quadrilateral shape is 16 mm or less.

In some implementations, the first quadrilateral shape includes an approximately rectangular shape.

In some implementations, a ratio of a length of the rectangular shape to a width of the rectangular shape is 1.1 or more.

In some implementations, a ratio of the length to the width is 2.0 or less.

In some implementations, an outer perimeter of the suspension defines a first circular shape, and an inner perimeter of the suspension defines a second circular shape, the first and second circular shapes being concentric.

In some implementations, an outer perimeter of the suspension defines a first shape having two opposing sides that are semicircular and two opposing sides that are straight, and an inner perimeter of the suspension defines a second shape having two opposing sides that are semicircular and two opposing sides that are straight, the first and second shapes being concentric.

Among other advantages, embodiments feature reduced temperature of a voice coil due to improved thermal conductivity of the suspension. Liquid metal polymers can combine mechanical advantages of polymers with thermal advantages of metal. When incorporated into a microspeaker suspension, an advantage is improvement of thermal conductivity of a microspeaker. The improved thermal conductivity can allow a microspeaker to operate at higher powers, lower temperatures, or both. In an example, for a power of one Watt applied to a voice coil of a microspeaker, a liquid metal polymer suspension can reduce coil temperature by ten degrees Celsius or more, compared to a polymer suspension. The improved thermal conductivity can permit the microspeaker to produce higher volume sound in a smaller size container. Microspeakers with liquid polymer suspensions can be used in devices such as mobile phones and wearable and hearable products.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an example suspension system for a microspeaker.

FIG. 2A is an exploded view of an example suspension and diaphragm for a microspeaker.

FIG. 2B is a schematic diagram of a cross-sectional view of a microspeaker.

FIG. 3 is a cross-sectional view of the example suspension and diaphragm of FIG. 2.

FIG. 4A is an overhead view of an example suspension for a microspeaker.

FIG. 4B is an overhead view of an example suspension and diaphragm including liquid channels. FIG. 4C illustrates an example shape of a liquid channel.

FIG. 5 is an overhead view of an embodiment of a mobile device including a microspeaker.

FIG. 6 is a schematic cross-sectional view of the mobile device of FIG. 5.

FIG. 7 is a schematic diagram of an embodiment of an electronic control module for a mobile device.

Like reference symbols in the various drawings indicate like elements.

### DETAILED DESCRIPTION

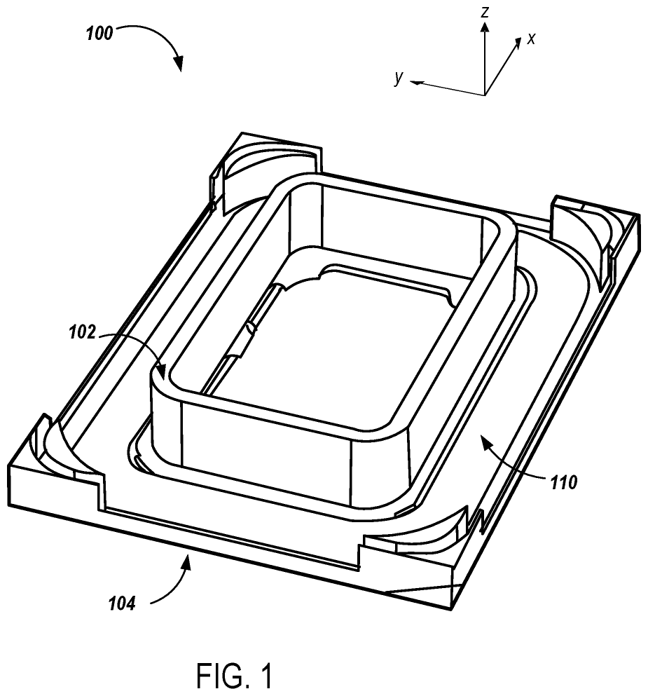

Referring to FIG. 1, microspeaker 100 includes a frame 104, a coil 102, and a suspension 110 that suspends the coil 102 within a space defined by the frame 104. A Cartesian coordinate system is shown in FIG. 1 for reference.

The coil 102 is positioned in the space such that the frame 104 extends around a perimeter of the coil 102. The suspension 110 suspends the coil 102 within the space relative to the frame 104. The suspension 110 attaches to the frame 104 and to the coil 102. The suspension 110 allows the coil 102 to vibrate in an axial direction, e.g., the z-direction, during operation of the microspeaker 100. During operation of the microspeaker 100, the frame 104 remains rigid, or substantially stationary, relative to the suspension 110 and to the coil 102.

The microspeaker 100 can be relatively compact. For example, the microspeaker, which has a substantially rectangular profile in the x-y plane, can have an edge length (i.e., in the x-and/or y-directions) of about 16 millimeters (mm) or less. For example, the edge length can be 15 mm, 12 mm, 10 mm, or 8 mm. The microspeaker's depth (i.e., its dimension in the z-direction) can be about 5.5 mm or less. For example, the microspeaker's depth can be about 5.0 mm, 4.0 mm, 3.0 mm, or 2.0 mm.

Generally, a reduced size of a microspeaker enables design flexibility, but the reduced size increases the power density in the coil and exacerbates thermal issues. Specifically, dimensions (length by width by depth) of microspeakers for mobile devices can range from approximately 16 mm by 12 mm by 5.5 mm, to 9 mm by 8 mm by 2 mm. Dimensions may be, for example, 15 mm length by 11 mm width, or 12 mm length by 6 mm width. Other example dimensions may be 10 mm diameter, 9 mm diameter, or 11 mm diameter in the x-y plane, with depth in the z-direction ranging from 5.5 mm to 2.2 mm. In some examples, a ratio of the length to the width is 1.5 or more. In some examples, a ratio of the length to the width is 2.0 or less.

A microspeaker may have a volume ranging from approximately 150 cubic millimeters to 1.5 cubic centimeters. A power density of the microspeaker may be, for example, 0.8 milliwatts per cubic millimeter (mW/mm³) or greater, 0.9 mW/mm³ or greater, or 1.0 mW/mm³ or greater. A power density of the microspeaker may be, for example, 2.0 mW/mm³ or less, 1.8 mW/mm³ or less, or 1.6 mW/mm³ or less.

Frame 104 has an approximately square or rectangular shape when viewed in the x-y plane. For example, an approximately square shape may have a ratio of length to width of 1.0 to 1.1. An approximately rectangular shape may have a ratio of length to width of 1.1 or greater. For example, an approximately rectangular shape may have a ratio of length to width of 3.0 or less, 2.0 or less, or 1.5 or less. Each corner of the frame is curved or bent so that the frame has rounded or sharp corners. Between each of the corners of frame 104 are portions of the frame that are substantially straight along their outside edges. Suspension 110 is coupled to frame 104 around the perimeter of the suspension. Although the frame 104 is depicted as having a quadrilateral shape in the x-y plane, other shapes are possible. For example, the frame can have a shape that is substantially elliptical, circular, oval, or round. In some examples, the frame has a shape with two opposing sides that are semicircular and two opposing sides that are straight. For example, the frame can have a shape similar to a shape of a racetrack.

Microspeakers can be characterized and quantified, in part, based on maximum sound pressure level (SPL) output and bandwidth. The maximum SPL can be determined by a combination of the sensitivity (e.g., efficiency) and by power handling. Sensitivity is negatively affected by elevated voice coil temperatures which cause power compression. Removing waste heat from the voice coil is key to maintaining sensitivity in operation.

The power handling of a device is limited by the ability to remove the excess heat generated. The thermal capacity of the voice coil can be quantified by a forced convection variable (Rtc(v)) and/or thermal resistance (Rth), which can be represented in units of Kelvin per Watt or Celsius per Watt. The thermal resistance is a first order approximation of the temperature rise of the voice coil for a given power input. For example, a voice coil rated at 100 C maximum temperature with a measured Rth of 50 C/W could operate at 100/50=2 W to reach the maximum temperature. A device with an Rth of 100 C/W could only operate safely at 1 W.

In some examples, thermal conductivity can be expressed as Watts per Kelvin (W/K) or Watts per milliKelvin (W/mK). PEEK microspeaker suspensions may have thermal conductivity of ˜0.25 W/mK. Replacing a PEEK microspeaker suspension with a thermally conductive suspension can increase thermal conductivity to approximately 4.8 W/mK or 9.8 W/mK. This increase can cause a reduction in voice coil temperature by up to 15 C.

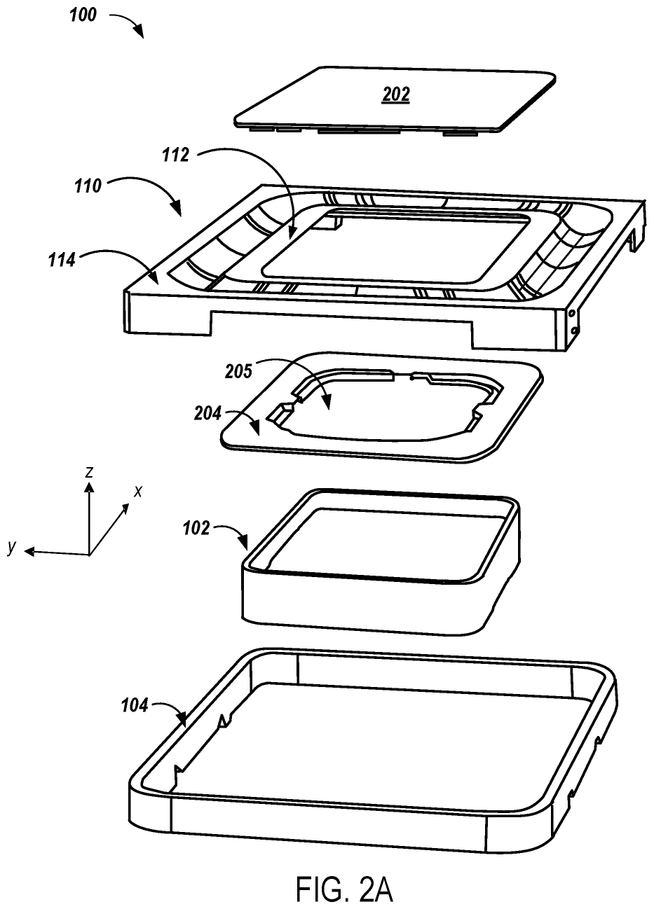

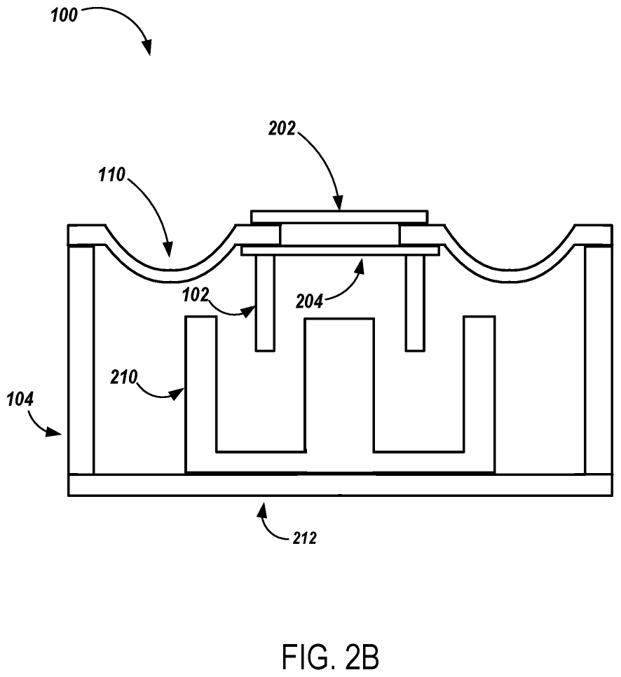

Referring to FIG. 2A, the suspension 110 includes an inner ring 112 and an outer ring 114. The inner ring 112 is coupled to the coil 102. At least a portion of the inner ring 112 is sandwiched between a diaphragm 202 and a rear plate 204. A top surface of the inner ring 112 is coupled to a bottom surface of the diaphragm 202. A microspeaker with dimensions of 12 mm length by 6 mm width can have a diaphragm with dimensions of, e.g., 7 mm length by 2 mm width. The diaphragm surface area can measure approximately 0.15 square centimeters (cm). In some examples, the suspension provides an additional 0.10 square centimeters of acoustical area.

The coil 102 can be coupled directly to the suspension 110 or can be coupled to a diaphragm 202 that is coupled to the suspension 110. The suspension 110 can act as a bridge between the stationary frame and the moving system including the diaphragm 202 and coil 102. The frame 104 may be mechanically and thermally coupled to the environment.

The suspension can have a low mass, e.g., with the moving part of the suspension being approximately one third to one half the mass of the voice coil. The coil 102 may be one half of the entire moving mass, with the remaining mass being the diaphragm. In an example microspeaker, the moving mass may be 16 milligrams (mg). The suspension can have spring-like characteristic to provide a restoring force to return the coil and diaphragm to the neutral position when the Lorentz force is removed. The restoring force can be described by the stiffness parameter Kms. An example stiffness parameter may be one Newton per millimeter. The reciprocal of stiffness is compliance, or Cms. Another key parameter for the suspension is to include a measure of mechanical resistive losses also known as damping, or Rms. An example Rms of the suspension is 49 grams per second.

A bottom surface of the inner ring 112 is coupled to a top surface of the rear plate 204. The rear plate 204 includes an aperture 205. The aperture is sized and shaped such that the coil 102 fits within the aperture 205. The coil 102 is configured to pass through the aperture 205 to contact the inner ring 112. In a typical embodiment the entire suspension, inner ring 112, and outer ring 114 would be the same material, but there could be embodiments where the materials could be different as in a co-mounded part.

The outer ring 114 is coupled to the frame 104. The size of the inner ring 112 and outer ring 114 can be selected on the basis of providing adequate attachment to the diaphragm 202, rear plate 204, and frame 104 respectively. The attachment can be approximately 0.5 mm wide and provided by an industrial adhesive. Suitable adhesives will exhibit toughness, high temperature tolerance, vibrational tolerance, and have long service life. Examples of adhesives that can be used are Acrylic PSA, EVA, CA, MA, PUR and PE.

The coil 102 is immersed in the magnetic field established by a magnetic assembly. When a variable current, e.g., an electrical audio signal, flows into the coil 102, a corresponding variable force is applied to the coil. The diaphragm 202, attached to the coil 102, vibrates accordingly and produces a sound of amplitude proportional to the diaphragm deviation from the state of rest. The deviation from the state of rest can be referred to as excursion.

During operation of microspeaker 100, the coil 102 moves in the z-direction in response to a Lorentz force resulting from interaction of a magnetic field of the magnetic assembly of the microspeaker with a changing magnetic field of the coil 102. The movement of the coil 102 causes the suspension 110 to bend in the z-direction. The suspension 110 applies a restoring force to the coil 102.

The locations of the connections of suspension 110 to the coil 102 are arranged so that the microspeaker has a desired resonant frequency. While the suspension 110, and components connected to the suspension 110, move in the z-direction, the frame 104 remains rigid relative to the suspension 110 and to the connected components.

In some examples, the dimensions of suspension 110, as measured in the x and y-dimensions, can be approximately equal. For example, suspension 110 can fit within a square having side lengths of about 16 mm or less.

FIG. 2B is a schematic diagram of a cross-sectional view of the microspeaker 100. Microspeaker 100 includes an electroacoustic transducer, or actuator, which converts an electrical audio signal into a corresponding sound. Audio output is generated by a vibrating diaphragm of the microspeaker 100.

The microspeaker 100 includes a magnetic assembly 210 including one or more magnets. The magnets of the magnetic assembly 210 can be, for example, iron magnets, neodymium magnets, or ferrite magnets, such as magnets composed of iron and nickel. In some embodiments, the magnetic assembly 210 can include an electromagnet. In some embodiments, the magnetic assembly 210 can include high permeability materials. The magnetic assembly 210 can be supported by a back plate 212.

During operation, an electric current is applied to the coil 102, which is located in a magnetic field of the magnetic assembly 210. The resulting magnetic flux causes vibration of the coil 102 in the axial direction. The resulting vibrations of the diaphragm 202 generate sound waves. The diaphragm 202 oscillates to produce sound waves in the air and therefore to make audible sound. The diaphragm 202 oscillates back and forth past a determinable center location, which may be the same as the location at which the diaphragm 202 is at rest when no electrical signal is being provided to the microspeaker 100 and when the pressure on both sides of the diaphragm are equal. The microspeaker can generate human-audible sound waves, e.g., in the range of 20 Hz to 20 kHz.

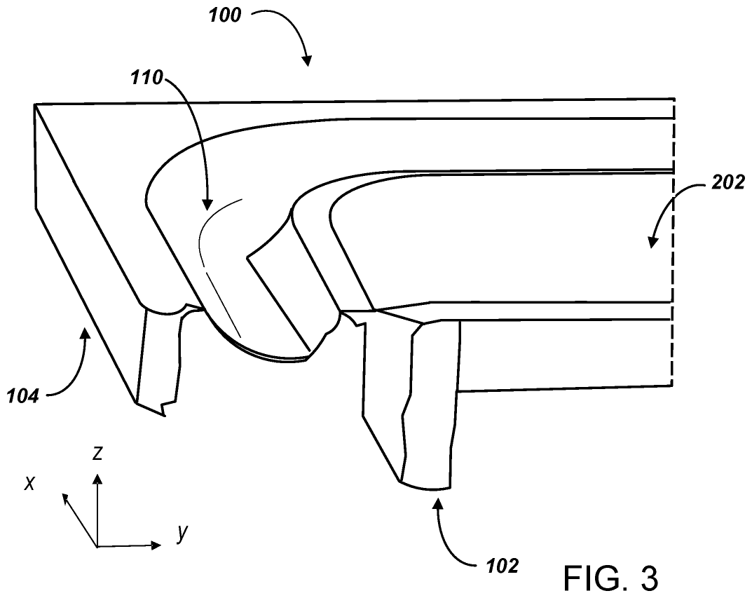

FIG. 3 is a cross-sectional view of the example suspension 110 and diaphragm 202 of FIGS. 2A and 2B. The suspension 110 can be made from a polymer or liquid metal polymer (LMP) material. A liquid metal polymer material can be a polymer material mixed with a liquid metal alloy. An LMP material can have strain dependent thermal conductivity which increases at high strain rates. In some examples, the LMP material can have conductivity that approximately doubles at high strain rates.

A polymer material can be, for example, polyethylene terephthalate (PET) or other thermoplastic polymer. In some examples, the polymer material can be a Polyetheretherketone (PEEK) laminate material.

Liquid metal particles can be mixed into polymer matrices to form composites with new or enhanced properties. Liquid-metal particles have a minimal impact on a polymer's extensibility because the particles themselves are liquid. Depending on the particle loading and size, adding liquid metal can increase an elastomer's tear strength by dulling cracks. Adding liquid-metal particles to elastomers can also increase the resulting composite's conductivity.

Stretching rubbery polymer composites loaded with liquid-metal particles causes the particles to elongate. The transition from spheres to ellipsoids generates anisotropic thermal conductivity, e.g., the ability to conduct heat in the direction of strain is enhanced.

Adding magnetic particles such as iron to liquid-metal composites can result in piezoconductivity, meaning the material becomes more conductive when strained; most composites instead possess piezoresistivity. In addition, composites loaded with liquid-metal particles can self-heal electrically when cut because the metal particles smear across the damaged region. Liquid-metal particles formed in liquid media can have diameters with length scales from tens of nanometers to hundreds of microns.

Particles of liquid metals can be formed by stirring the metal in the presence of another liquid. Mixing liquid metal, e.g., eutectic gallium indium (EGaIn), into silicone, e.g., polydimethylsiloxane (PDMS) creates a soft composite upon curing the silicone. Example LMP materials can include platinum-catalyzed silicone elastomer embedded with a randomly distributed, polydisperse suspension of nontoxic, liquid-phase eutectic gallium—indium (EGaIn) microdroplets.

The thermal composite can be fabricated by shear mixing EGaIn alloy (75% Ga, 25% In, by weight; Gallium Source) with an uncured silicone elastomer (Ecoflex 00-30; Smooth-On). In some examples, a volume fraction of liquid metal particles, or droplets, is ten percent or more. In some examples, a volume fraction of liquid metal droplets is fifty percent or less.

During mixing, liquid metal droplets can form a self-passivating coating such as a Ga₂O₃ coating that helps prevent coalescence and eliminates the need to add surfactants or other dispersing agents. The droplets can have a statistically uniform spatial distribution and are polydisperse, with a median diameter of approximately fifteen microns.

In some examples, by incorporating liquid metal microdroplets into a soft elastomer, the material can achieve approximately a twenty-five time increase in thermal conductivity over the base polymer under stress-free conditions and approximately a fifty time increase in thermal conductivity when strained.

Adding liquid metal particles to polymer material, or rubber, results in the composite material remaining soft. Elastomer composite embedded with elongated inclusions of liquid metal that function as thermally conductive pathways. These composites can exhibit a combination of low stiffness (e.g., 100 kPa or less), high strain limit (e.g., 600% or greater), and metal-like thermal conductivity (e.g., 9.8 Wm⁻¹K⁻¹ or greater)

In some examples, the LMP material can be prestressed in order to program the material to achieve permanently elongated liquid metal inclusions in a stress-free state. For example, the LMP material can be stretched to 600% strain and then unloaded to zero stress. An unrecoverable plastic strain of approximately 200% is induced, enabling elongated inclusions in an unloaded (stress-free) state. Thermal conductivity of the programmed sample in the longitudinal direction can be approximately twenty-five times greater than that of the base elastomer.

Liquid particles can be mechanically sintered by pushing the particles together. Straining or compressing composites that contain liquid metals can change the particles' geometries within the elastomer. Deformable liquid metal inclusions elongate into needle-like microstructures along the prestressed or mechanically loaded direction to create enhanced thermally conductive pathways. In a liquid metal polymer suspension, the material can be prestressed, e.g., in a radial direction to improve thermal conductivity between the coil 102 and the frame 104.

The material composition of the suspension 110 should be sufficiently resilient so that the suspension 110 does not deform or fatigue as a result of repetitive movement during operation of the actuator (e.g., microspeaker 100). The material should also be able to withstand forces that may occur due to dropping a device that contains the microspeaker 100. The material composition of the suspension 110 can also be selected based on density and weight. For example, a material can be selected that does not increase the weight of the suspension by more than a percentage of weight, e.g., twenty percent, thirty percent, forty percent, etc.

The material composition of the suspension 110 can be selected based on the desired damping effects on the actuator such as the desired fundamental frequency and quality factor (Q factor). For example, a material can be selected that changes the fundamental frequency by less than a maximum amount. The maximum amount can be, for example, ten percent, eight percent, five percent, etc.

A thickness of the suspension 110 in the z-direction can vary from approximately 0.05 mm to 0.2 mm. The thickness of the suspension 110 can be selected based on the size profile of the actuator, the desired robustness of the actuator, and the damping effects on the actuator. The thickness of the suspension 110 can be selected based on the size profile of the actuator, the desired adhesiveness, and the desired damping effects on the actuator. In some cases, the thickness of the suspension 110 may be variable.

In some implementations, the thickness of the suspension remains constant across the entire suspension. By designing it so, the suspension may be produced from sheet stock. In some examples, the suspension can be molded with equal thickness or with reduced thickness sections. Changes in suspension thickness can be made either to linearize the restoring force (Kms), to provide a gradual change in acoustic impedance, or to retain the shape of a critical feature.

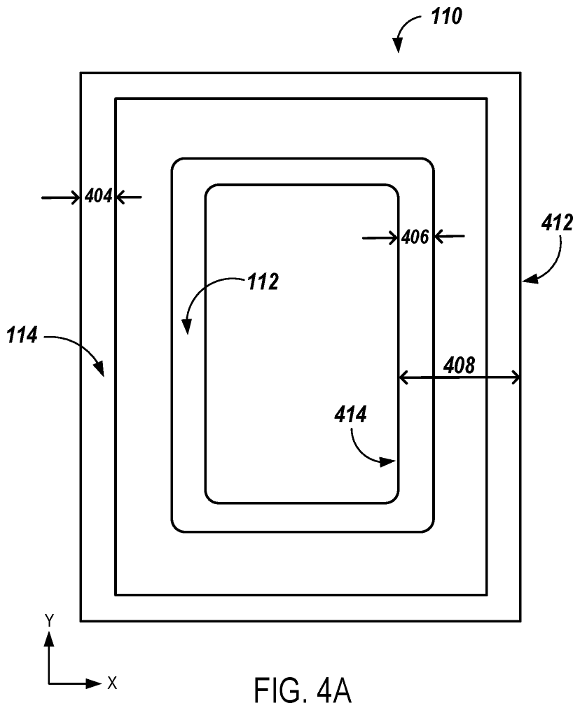

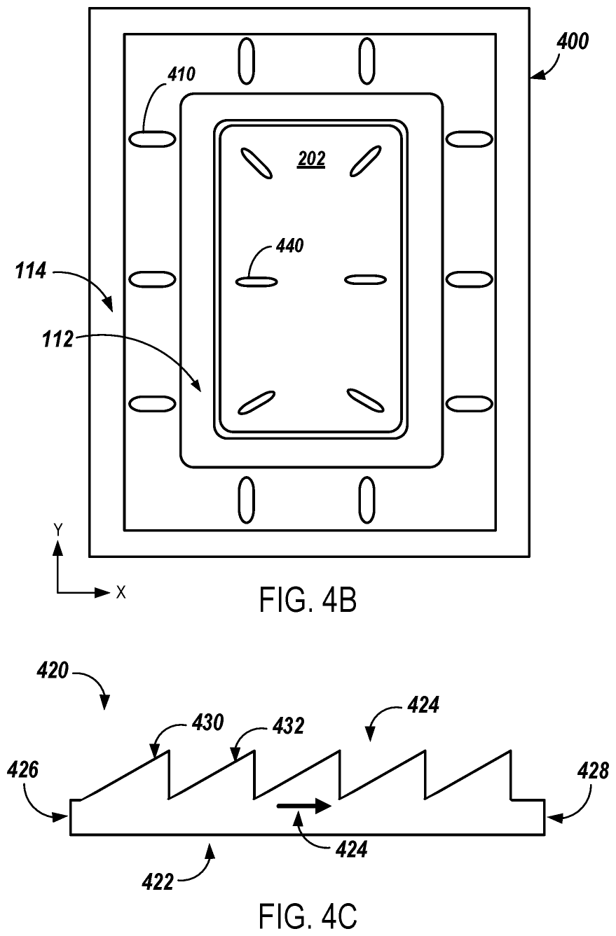

FIG. 4A shows an overhead view of the suspension 110. A Cartesian coordinate system is shown in FIG. 4A for reference. The suspension 110 extends substantially in a plane, e.g., the x-y plane. The suspension 110 includes an outer perimeter 412 defining a first quadrilateral shape. The suspension 110 includes an inner perimeter 414 defining a second quadrilateral shape with rounded corners. The inner perimeter 414 and the outer perimeter 412 are concentric in a plane, e.g., the x-y plane.

In some embodiments, the quadrilateral shapes defined by the inner perimeter 414 and the outer perimeter 412 are each an approximately rectangular shape or an approximately square shape. For example, an approximately square shape may have a ratio of length to width of 1.0 to 1.1. In some embodiments, the shapes defined by the inner perimeter 414 and the outer perimeter 412 are each a racetrack shape having two opposing sides that are semicircular and two opposing sides that are straight. In some embodiments, an example length of the shape defined by the outer perimeter can be from 6 mm to 16 mm. An example width can be from 4 mm to 12 mm.

A distance between the outer perimeter 412 and the inner perimeter 414 defines a width 408 of the suspension 110. The width 408 of the suspension 110 can vary around the perimeter of the suspension 110. The inner ring 112 has a width 406. The width 408 of the inner ring 112 can vary around the perimeter of the suspension 110. The outer ring 114 has a width 404. The width 408 of the outer ring 114 can vary around the perimeter of the suspension 110. The overall width of a radial microspeaker suspension may be 1 mm or less, or 2 mm or less. In some examples, the width of the suspension is 1 mm or more. Radial widths of the inner ring 406 and outer ring 404 can be engineered to provide adequate attachment to the diaphragm and frame and as such may be in the range of 0.3 mm to 0.6 mm wide. In a rectangular design the corners may be wider than the straight sections. This can be implemented to counteract the higher stresses in the corners.

Suspension 110 shares approximately the same shape as the frame 104 when viewed in the x-y plane. The corners of suspension 110, as viewed in the x-y plane, can be sharp or curved. The sides of suspension 110, between the corners of the suspension, are substantially straight.

While the foregoing figures cover a specific embodiment of a microspeaker i.e., microspeaker 100, more generally the principles embodied in this example can be applied in other designs too. For example, while microspeaker 100 has a substantially rectangular footprint (i.e., in the x-y plane), other shapes are possible, such as substantially square, oval, circular, or round.

In some examples, the suspension can include channels of liquid metal coolant. FIG. 4B is an overhead view of an example suspension 400 and diaphragm 202 including liquid channels. FIG. 4C illustrates an example shape of a liquid channel 420. The channels can extend in a radial direction, e.g., from the inner ring 112 towards the outer ring 114. In some examples, liquid metal channels can include fluid diodes. The fluid diodes can conduct the liquid metal, and therefore heat, in a direction from the coil 102 to the frame, e.g., from the inner ring 112 towards the outer ring 114.

In some examples, the liquid metal channels can direct liquid metal to circulate outward from the center of the suspension and to return towards the center of the suspension. For example, the suspension 400 includes channel rings 410 on a top surface of the suspension 400. In some examples, the suspension 400 can include channel rings 410 on a bottom surface (not shown) of the suspension 400 instead of, or in addition to, the channel rings 410 on the top surface.

In some examples, the channel rings 410 are etched into the surface of the suspension 400. In some examples, the suspension 400 is formed from an LMP material, and the channels contain liquid metal. In some examples, the suspension 400 is formed from a polymer material, and the channels contain liquid metal. In some examples, the suspension 400 can include two layers of polymer material. A first, bottom layer can include channels that contain liquid metal. A second, top layer can be positioned on top of the first, bottom layer, sandwiching the channels of liquid metal between the top layer and the bottom layer.

In the example of FIG. 4B, each channel ring 410 includes a liquid metal channel that forms a loop. The channel rings 410 each have a long dimension that extends outward, e.g., from the inner ring 112 towards the outer ring 114. The long dimension of a channel ring 410 can extend, for example, along the x-direction, the y-direction, or in a radial direction in the x-y plane. Liquid metal flows through the channel rings, outward towards the outer ring 114 and returning inward towards the inner ring 112.

The suspension 400 can include any number of channel rings 410. In some examples, the channel rings 410 are positioned at intervals around the suspension 400. In some examples, the channel rings 410 are symmetrically arranged with respect to the x-axis, the y-axis, or both. In the example suspension 400, the channel rings 410 each form a racetrack shape. In some examples, channel rings can form other shapes, e.g., circular, elliptical, oval.

In some examples, fluid diodes in the channels can use a pumping action, capillary action, or both, to conduct liquid metal away from the coil 102. Flow in one direction of a channel can be optimized to have lower resistance to flow compared flow in the opposite direction. The liquid metal material will naturally circulate in the path of least resistance. The flow can be augmented by providing squeezing stress from the natural movement of the diaphragm. Where there is an imbalance in the resistance to flow and a stimulus, the liquid metal will circulate.

FIG. 4C illustrates an example shape of a portion 420 of a channel ring 410. The portion 420 of the channel ring 410 has a sawtooth pattern, with a flat edge 422 and a jagged edge 424 opposite from the flat edge 422.

The portion 420 of the channel ring 410 can be formed on a surface of the suspension 110, e.g., through etching. A saw-tooth liquid-filled structure will show a preference in flow direction with an equal pressure difference. For example, in the portion 420, liquid metal in the channel has a preference to flow in the direction of arrow 424, when pressure is equal between position 426 and position 428 of the channel. Each “tooth” of the sawtooth pattern, e.g., tooth 430 and tooth 432, can function as a fluid diode, causing a preferential flow in the direction of arrow 424 for liquid metal in the portion 420 of the channel ring 410.

In some examples, the channel rings 410 can include fluid diodes formed as ratchets that tilt towards the intended direction of flow. Each ratchet can include both transverse and longitudinal curvature on its upper surface and a flat, smooth bottom surface. For example, the fluid diodes can include an Araucaria leaf-inspired surface that moves liquid metal by capillary action. The fluid diodes can be used for directional steering of the liquid metal.

In some examples, the diaphragm 202 can include liquid metal channels, in addition to or instead of the suspension 110 having liquid metal channels. For example, the diaphragm 202 can include channel rings 440 that conduct liquid metal from edges of the diaphragm 202 inward towards the center of the diaphragm, and outwards from the center towards the edges. The liquid metal channels of the diaphragm can conduct heat away from the coil 102, which may be mechanically coupled to the diaphragm 202 or to the inner ring 112. During operation, the diaphragm 202 oscillates along the z-direction. Heat from the coil 102, conveyed by liquid metal in the channel rings 440 of the diaphragm 202, can be released to atmosphere, e.g., through pumping action caused by oscillation of the diaphragm 202.

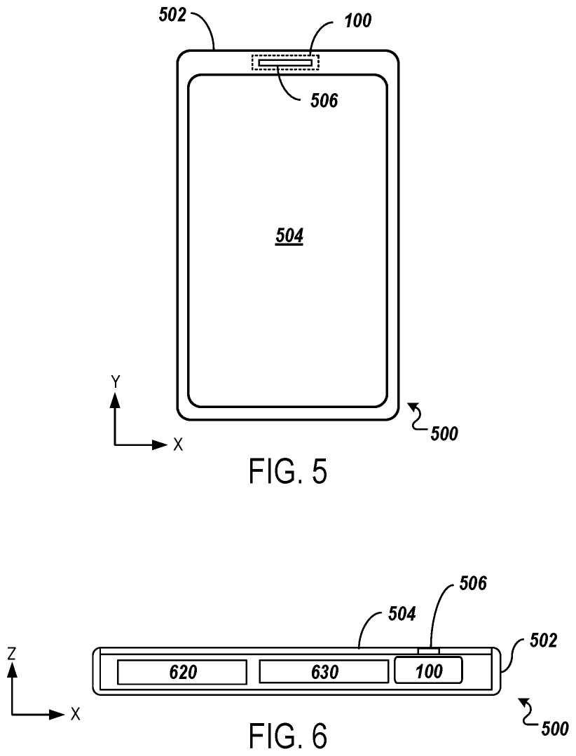

In general, the microspeakers described above can be used in a variety of applications. For example, in some embodiments, microspeaker 100 can be integrated into a mobile device, such as a mobile phone. For example, referring to FIG. 5, a mobile device 500 includes a device chassis 502 and a touch panel display 504 including a flat panel display (e.g., an OLED or LCD display panel). Mobile device 500 interfaces with a user in a variety of ways, including by displaying images and receiving touch input via touch panel display 504. Typically, a mobile device has a depth (in the z-direction) of approximately 10 mm or less, a width (in the x-direction) of 60 mm to 80 mm (e.g., 68 mm to 72 mm), and a height (in the y-direction) of 100 mm to 160 mm (e.g., 138 mm to 144 mm).

Mobile device 500 also produces audio output. During operation, the mobile device 500 uses a speaker, e.g., microspeaker 100 to generate audible sound for a user. Such sound may include sound from voice telephone calls, may include recorded sound (e.g., voice messages, music files, etc.) and may also include sound generated by applications operating on mobile device 500. Audio output from the microspeaker can exit the chassis 502 through an aperture 506. The aperture 506 can be an opening in the chassis 502 or panel 504.

Referring to FIG. 6, a cross-section of mobile device 500 illustrates device chassis 502 and touch panel display 504. Device chassis 502 has a depth measured along the z-direction and a width measured along the x-direction. Device chassis 502 also has a back panel, which is formed by the portion of device chassis 502 that extends primarily in the x-y plane. Mobile device 500 includes microspeaker 100, which is housed in chassis 502 and positioned adjacent to the aperture 506. Generally, microspeaker 100 is sized to fit within a volume constrained by other components housed in the chassis, including an electronic control module 620 and a battery 630.

Although FIG. 6 shows microspeaker 100 as an internal component of mobile device 500, it should be appreciated that microspeaker 100 can also be implemented as an external and/or independent device. For instance, microspeaker 100 can be a stand-alone speaker that communicates with mobile device 500 using a wireless technology standard, such as Bluetooth, to output audio generated from the mobile device 500. The disclosed techniques are applicable to larger scale transducers, such as home speakers, automotive speakers, and the like.

In general, the disclosed speakers are controlled by an electronic control module, e.g., electronic control module 620. In general, electronic control modules are composed of one or more electronic components that receive input from one or more sensors and/or signal receivers of the mobile phone, process the input, and generate and deliver signal waveforms that cause microspeaker 100 to provide audio output.

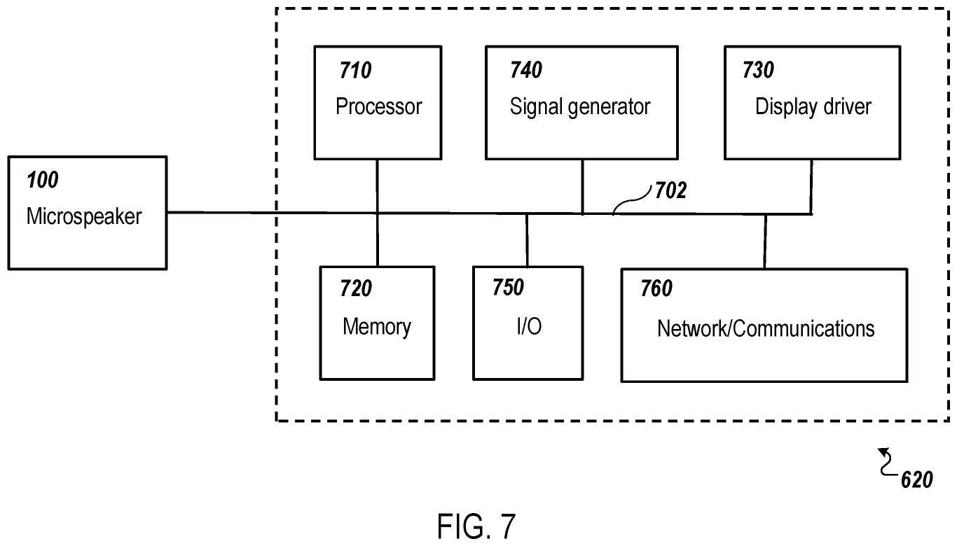

Referring to FIG. 7, an exemplary electronic control module 620 of a mobile device, such as mobile device 500, includes a processor 710, memory 720, a display driver 730, a signal generator 740, an input/output (I/O) module 750, and a network/communications module 760. These components are in electrical communication with one another (e.g., via a signal bus 702) and with microspeaker 100.

Processor 710 may be implemented as any electronic device capable of processing, receiving, or transmitting data or instructions. For example, processor 710 can be a microprocessor, a central processing unit (CPU), an application-specific integrated circuit (ASIC), a digital signal processor (DSP), or combinations of such devices.

Memory 720 has various instructions, computer programs or other data stored thereon. The instructions or computer programs may be configured to perform one or more of the operations or functions described with respect to the mobile device. For example, the instructions may be configured to control or coordinate the operation of the device's display via display driver 730, signal generator 740, one or more components of I/O module 750, one or more communication channels accessible via network/communications module 760, one or more sensors (e.g., biometric sensors, temperature sensors, accelerometers, optical sensors, barometric sensors, moisture sensors and so on), and/or microspeaker 100.

Signal generator 740 is configured to produce AC waveforms of varying amplitudes, frequency, and/or pulse profiles suitable for microspeaker 100 and producing acoustic and/or haptic responses via the actuator. Although depicted as a separate component, in some embodiments, signal generator 740 can be part of processor 710. In some embodiments, signal generator 740 can include an amplifier, e.g., as an integral or separate component thereof

Memory 720 can store electronic data that can be used by the mobile device. For example, memory 720 can store electrical data or content such as, for example, audio and video files, documents and applications, device settings and user preferences, timing and control signals or data for the various modules, data structures or databases, and so on. Memory 720 may also store instructions for recreating the various types of waveforms that may be used by signal generator 740 to generate signals for microspeaker 100. Memory 720 may be any type of memory such as, for example, random access memory, read-only memory, Flash memory, removable memory, or other types of storage elements, or combinations of such devices.

As briefly discussed above, electronic control module 620 may include various input and output components represented in FIG. 7 as I/O module 750. Although the components of I/O module 750 are represented as a single item in FIG. 7, the mobile device may include a number of different input components, including buttons, microphones, switches, and dials for accepting user input. In some embodiments, the components of I/O module 750 may include one or more touch sensors and/or force sensors. For example, the mobile device's display may include one or more touch sensors and/or one or more force sensors that enable a user to provide input to the mobile device.

Each of the components of I/O module 750 may include specialized circuitry for generating signals or data. In some cases, the components may produce or provide feedback for application-specific input that corresponds to a prompt or user interface object presented on the display.

As noted above, network/communications module 760 includes one or more communication channels. These communication channels can include one or more wireless interfaces that provide communications between processor 710 and an external device or other electronic device. In general, the communication channels may be configured to transmit and receive data and/or signals that may be interpreted by instructions executed on processor 710. In some cases, the external device is part of an external communication network that is configured to exchange data with other devices. Generally, the wireless interface may include, without limitation, radio frequency, optical, acoustic, and/or magnetic signals and may be configured to operate over a wireless interface or protocol. Example wireless interfaces include radio frequency cellular interfaces, fiber optic interfaces, acoustic interfaces, Bluetooth interfaces, Near Field Communication interfaces, infrared interfaces, USB interfaces, Wi-Fi interfaces, TCP/IP interfaces, network communications interfaces, or any conventional communication interfaces.

In some implementations, one or more of the communication channels of network/communications module 760 may include a wireless communication channel between the mobile device and another device, such as another mobile phone, tablet, computer, or the like. In some cases, output, audio output, haptic output or visual display elements may be transmitted directly to the other device for output. For example, an audible alert or visual warning may be transmitted from the mobile device 500 to a mobile phone for output on that device and vice versa. Similarly, the network/communications module 760 may be configured to receive input provided on another device to control the mobile device. For example, an audible alert, visual notification, or haptic alert (or instructions therefor) may be transmitted from the external device to the mobile device for presentation.

The actuator technology disclosed herein can be used in a device such as a smartphone, tablet computer, or wearable devices (e.g., smartwatch or head-mounted device, such as smart glasses).

Other embodiments are in the following claims.

1. A microspeaker, comprising:
a frame defining a space;
a coil positioned in the space such that the frame extends around a perimeter of the coil; and
a suspension suspending the coil within the space relative to the frame, wherein the suspension is coupled to the frame and to the coil and allows the coil to vibrate in an axial direction during operation of the microspeaker, the suspension comprising a liquid metal polymer material.

2. The microspeaker of claim 1, wherein a power density of the microspeaker is 0.8 milliwatts per cubic millimeter or greater.

3. The microspeaker of claim 1, wherein the suspension is formed from liquid metal particles embedded in a polymer matrix.

4. (canceled)

5. The microspeaker of claim 1, wherein the liquid metal polymer material is prestressed in a radial direction, the radial direction extending from the coil towards the frame.

6. The microspeaker of claim 1, wherein the suspension includes one or more liquid metal channels.

7. The microspeaker of claim 6, wherein the one or more liquid metal channels extend radially from the coil towards the frame.

8. The microspeaker of claim 6, wherein the one or more liquid metal channels each includes at least one fluid diode that directs a flow of liquid metal in a direction from the coil towards the frame.

9. (canceled)

10. The microspeaker of claim 1, wherein a thickness of the suspension in the axial direction is 0.2 millimeters or less.

11. The microspeaker of claim 1, wherein a volume fraction of liquid metal particles in the suspension is ten percent or greater and fifty percent or less.

12. (canceled)

13. The microspeaker of claim 1, wherein:
an outer perimeter of the suspension defines a first quadrilateral shape, and
an inner perimeter of the suspension defines a second quadrilateral shape,
the first and second quadrilateral shapes being concentric.

14. The microspeaker of claim 13, wherein:
a distance between the outer perimeter and the inner perimeter defines a width of the suspension,
the width of the suspension is 2 mm or less, and
the width of the suspension is 1 mm or more.

15. (canceled)

16. (canceled)

17. The microspeaker of claim 13, wherein the first quadrilateral shape and the second quadrilateral shape each comprise a square shape.

18. The microspeaker of claim 13, wherein a length of each side of the first quadrilateral shape is 16 mm or less.

19. The microspeaker of claim 13, wherein:
the first quadrilateral shape comprises a rectangular shape,
a ratio of a length of the rectangular shape to a width of the rectangular shape is 1.1 or more, and
a ratio of the length of the rectangular shape to the width of the rectangular shape is 2.0 or less.

20. (canceled)

21. (canceled)

22. The microspeaker of claim 1, wherein:
an outer perimeter of the suspension defines a first circular shape, and
an inner perimeter of the suspension defines a second circular shape,
the first and second circular shapes being concentric.

23. The microspeaker of claim 1, wherein:
an outer perimeter of the suspension defines a first shape having two opposing sides that are semicircular and two opposing sides that are straight, and
an inner perimeter of the suspension defines a second shape having two opposing sides that are semicircular and two opposing sides that are straight,
the first and second shapes being concentric.

24. A mobile device, comprising the microspeaker of claim 1.

25. A wearable device, comprising the microspeaker of claim 1.

26. The microspeaker of claim 1, the liquid metal polymer material comprising polydisperse liquid metal droplets embedded in an elastomer.

27. The microspeaker of claim 26, the liquid metal droplets having a statistically uniform spatial distribution in the suspension.
